(19) United States
(12) Patent Application Publication
(10) Pub. No.: US 2013/0295418 A1
(43) Pub. Date: Nov. 7, 2013

(54) ELECTROCHEMICAL ENERGY STORE COMPRISING AN ATTACHMENT ELEMENT

(71) Applicant: Tim Schaefer, Harztor (DE)

(72) Inventor: Tim Schaefer, Harztor (DE)

(73) Assignee: LI-TEC BATTERY GMBH, Kamenz (DE)

(21) Appl. No.: 13/883,919

(22) PCT Filed: Oct. 27, 2011
(86) PCT No.: PCT/EP2011/005433

§ 371 Date: Jul. 25, 2013

(30) Foreign Application Priority Data
Nov. 8, 2010 (DE) 10 2010 050 746.6

(51) Int. Cl. H01M 2/10

(52) U.S. Cl. CPC H01M 2/1016; H01M 2/1022; H01M 2/1072
USPC 429/10; 29/623.1

(57) ABSTRACT

The invention relates to an electrochemical energy store (301, 401), comprising a first attachment element (306, 308, 409, 410, 411, 412) which is designed in such a manner that, when such a first electrochemical energy store (319), or at least one such first attachment element of said first such electrochemical energy store, is pressed against a second such electrochemical energy store (320) or against at least one second such attachment element of said second such electrochemical energy store (320), an attachment of the first electrochemical energy store to the second electrochemical energy store takes place.

The invention relates to an electrochemical energy store, an arrangement of a plurality of such electrochemical energy stores, a method for producing such an electrochemical energy store and a method for producing an arrangement of a plurality of such electrochemical energy stores.

Electrochemical energy stores are needed for an enormous variety of applications, and accordingly they are integrated in an extremely wide range of environments and used according to the requirements of the applications in various arrangements in which a plurality of electrochemical energy stores are connected together for the purpose of providing a voltage or capacitance appropriate for the requirements of the application through a series or parallel circuit of a plurality of electrochemical energy stores.

In this context, the attachment of the electrochemical energy stores to each other or in their application environment, and in some applications even the contacting of the electrical connectors of such electrochemical energy stores in order to create the series or parallel circuit appropriate for the application are decisive. For these problems, a number of different solutions have been presented:

For example, DE 21 58 525 describes a device for the electrical connection and attachment of an electrical conductor to an electric power tap of an electrochemical energy store in the form of a pole stud of rechargeable battery.

Document DE 22 50 373 describes a battery connector terminal having a metallic terminal in the form of an arcuate, tubular fork ring with two clamp legs and having an inner conical contact surface that enable it to be placed on the outer surface on a conical connecting pin of a battery, and having an external housing that surrounds the fork ring while leaving its contact surface exposed and is manufactured from a resin-based plastic material by injection moulding, casting or stamping.

Document DE 39 42 241 A1 describes a screwless battery terminal with a tongue for connection to a cable and cups enclosing the respective terminal, wherein the cup is made in two parts and consists of two half-cups, of which one half-cup holds the tongue and has two tangential arms that are supported in a corrugation of the tongue.

The object of the present invention is to provide the simplest, most effective technical teaching possible for attaching electrochemical energy stores or for constructing arrangements of a plurality of such energy stores, that avoids or overcomes the drawbacks or limitations of the known solutions as far as possible. This object is solved with a device according to any of the independent device claims and with a method according to any of the independent method claims. Advantageous refinements of the invention are the object of subordinate claims.

According to the invention, an electrochemical energy store is provided that has at least a first attachment element. This first attachment element is preferably designed in such manner that when a first of such electrochemical energy stores or at least a first such attachment element of this first of such electrochemical energy stores is pressed against a second of such electrochemical energy stores or against at least a second such attachment element of this second of such electrochemical energy stores, the first electrochemical energy is fastened to the second electrochemical energy store.

In this context, an electrochemical energy store is understood to mean a device that stores energy in chemical form and is able to deliver it to a consumer in electrical form. Some forms of such electrochemical energy stores, also known as secondary electrical energy stores, can also receive energy in electrical form from source and store it in chemical form, that is to say they are capable of being charged. Electrochemical energy stores preferably include an electrochemically active part, which is preferably located in a housing or a package, out of which electrical connectors can preferably protrude in such manner that these connectors are able to come into contact with their surroundings. The electrical connectors are connected in electrically conductive manner with the electrochemically active components of the electrochemical energy store, particularly the electrodes, pairs of which are preferably kept apart from one another by separator materials, which separator materials are preferably permeable for certain ions of an electrolyte but effectively prevent an electrical short circuit between the electrodes.

In this context, the term attachment element is understood to mean any property or device of an electrochemical energy store that is suitable for attaching this electrochemical energy store to another electrochemical energy store or a construction element in the application environment thereof, for example to a retaining element. This is preferably effected by pressing an electrochemical energy store according to the invention against an adjacent electrochemical energy store or a corresponding attachment element that is designed such that pressing them together creates a corresponding attachment.

Such attachment elements may be integrated moulded parts of the electrochemical energy store, its housing, one of its electrical connectors, or other components of the electrochemical energy store that are accessible from the outside. Alternatively, however, such attachment elements may also be affixed to the electrochemical energy store, its housing or one of the electrical connectors thereof, or to other components of the electrochemical energy store that are accessible from the outside by adhesion, welding, heat sealing, or in some other way.

According to a preferred embodiment of the invention, an electrochemical energy store is provided in which at least one attachment element is designed such that the attachment is broken again when a tractive force above a tractive force threshold is applied thereto. Accordingly, the intended attachment is preferably created by pressing two elements together and broken again by the effect of a tractive force acting preferably in the opposite direction to the pressing force, if this tractive force, that is to say the value there-of, is greater than a tractive force threshold. The tractive force threshold is preferably such that when an electrochemical energy store is operated within its normal operating parameters or used for its intended application the attachment does not or is unlikely to be become detached.

According to a further preferred embodiment of the invention, an electrochemical energy store is provided having at least two complementary attachment elements, which are constructed such that when at least a first attachment element of a first such electrochemical energy store is pressed against a second attachment element, complementary to the first attachment element, of a second such electrical energy store, an attachment is created between the first electrochemical energy store and the second electrochemical energy store.

According to a further preferred embodiment of the invention, an electrochemical energy store is provided in which the first attachment element has an outwardly protruding, preferably spherical body, which when pressed against a second attachment element complementary to the first attachment element engages with or snaps into a preferably hollow spherical recess present in the second attachment element.

According to a further preferred embodiment of the invention, an electrochemical energy store is provided in which the first and/or second attachment element is produced at least in part from an elastic material. Preferably, metallic elastic materials or elastic plastics are used for this. One advantage of elastic materials in this context is that the use of complicated mechanical constructions to lock the attachment elements together may largely be dispensed with.

According to a further preferred embodiment of the invention, an electrochemical energy store is provided in which the first or second attachment element is equipped with at least one spring element. Possible spring elements in this context may preferably be of the leaf type or wire elastic devices, preferably fitted at the openings of recesses in attachment elements to enable outwardly protruding, preferably spherical bodies on complementary attachment elements to snap into these recesses. Some embodiments of the attachment elements according to the invention are similar in function to the press studs known from textile engineering, which may also be fastened together by pressing against one another in such manner that the attachment may be released again by the effect of a tractive force above a tractive force threshold.

According to a further preferred embodiment of the invention, an electrochemical energy store is provided in which at least one attachment element is equipped with a permanent magnet. Particularly in conjunction with other magnetic or magnetisable, preferably metallic materials, the use of permanent magnets in the context of attachment elements on energy stores according to the invention enables a simple, effective connection to be made that can also be released very easily.

Such permanent magnets may also be used in combination with elastic materials in such manner that an attachment is not created until the attachment elements furnished with such permanent magnets are pressed together, because a repelling elastic force must first be overcome by pressing before the permanent magnet approaches its attractive range. Once this has happened, the attractive force of the permanent magnet is sufficient to establish the attachment, and such attachments may also be broken again by the effects of tractive forces above a given tractive force threshold.

According to a further preferred embodiment of the invention, an electrochemical energy store is provided in which the electrical connectors of the electrochemical energy store are designed in such manner that when a first such electrochemical energy store is attached to a second electrochemical energy store an electrical contact is created between at least some of the electrical connectors of both electrochemical energy stores. The electrical connectors of the electrochemical energy stores that are designed in this way are preferably connected in electrically conductive manner to at least some of the attachment elements for this purpose, so that electrical contact is established automatically as soon as an attachment is created. In other embodiments of the invention, the electrical connectors may themselves be equipped with attachment elements, so that the attachment of the energy stores and therewith also the contacting of the electrical connectors is created via the electrical connectors thereof.

According to a further preferred embodiment of the invention, an electrochemical energy store is provided in which the electrical connectors are designed in such a way that the electrical contact is interrupted when the attachment is separated.

According to a further preferred embodiment of the invention, an electrochemical energy store is provided in which the electrical connectors or the attachment elements of the electrochemical energy store, of which at least some are connected therewith in electrically conductive manner, are designed in such manner that they counteract a polarity reversal of the electrochemical energy stores or the connectors thereof when an arrangement is being constructed from at least two such energy stores.

In this context, the invention preferably provides attachment elements that are offset with respect to each other, particularly preferably attachment elements that are horizontally and/or vertically offset with respect to each other, and/or attachment elements of differing, unmatched shapes, and particularly preferably the use of a plurality of sets of attachment elements of complementary designs that match other elements of the set but not elements belonging to different sets.

According to the invention, an arrangement of a plurality of electrochemical energy stores is also provided, particularly such an arrangement in which adjacent electrochemical energy stores are fastened to each other in pairs by fastening means that are designed in such manner that when a first such electrochemical energy store, or at least a first such attachment element of said first electrochemical energy store of this kind is pressed against a second such electrochemical energy store or against at least a second such attachment element of said second electrochemical energy store of such kind an attachment is created between the first electrochemical energy store and the second electrochemical energy store.

According to the invention, a method for producing an electrochemical energy store is also provided in which the housing or the electrical connectors of the electrochemical energy store are designed in such manner that the electrochemical energy store has a first attachment element, which is designed in such manner that when a first such electrochemical energy store, or at least a first such attachment element of said first electrochemical energy store of this kind is pressed against a second such electrochemical energy store or against at least a second such attachment element of said second electrochemical energy store of such kind an attachment is created between the first electrochemical energy store and the second electrochemical energy store.

The attachment elements may preferably be integrated in the housing or in the form of the electrical connectors of the energy store. In other embodiments of the invention, the attachment elements may be affixed to the housing or to the electrical connectors of the energy store afterwards.

According to the invention, a method for producing an arrangement of a plurality of electrochemical energy stores is also provided in which adjacent electrochemical energy stores are attached to one another in pairs by attachment means so that an attachment is created between the first electrochemical energy store and the second electrochemical energy store by pressing a first such electrochemical energy store, or at least a first such attachment element of said first electrochemical energy store of this kind against a second such electrochemical energy store or against at least a second such attachment element of said second electrochemical energy store of such kind.

The features of these or other embodiments of the invention may also be combined with each other advantageously.

In the following, the invention will be described in greater detail with reference to preferred embodiments and with the aid of the drawing.

In the drawing:

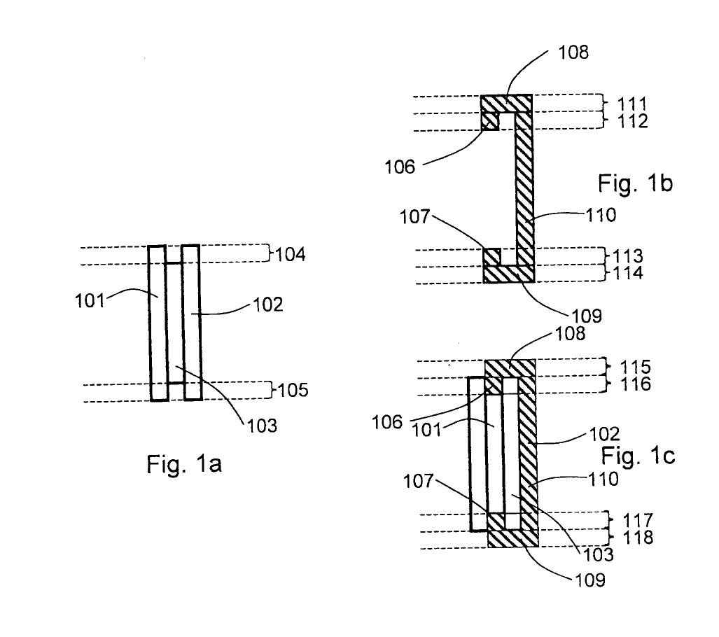

FIG. 1a is a diagrammatic representation of a preferred embodiment of a first attachment element according to the invention;

FIG. 1b is a diagrammatic representation of a preferred embodiment of a second attachment element according to the invention;

FIG. 1c is a diagrammatic representation of the cooperation between a first and a second attachment element according to the invention to create an attachment;

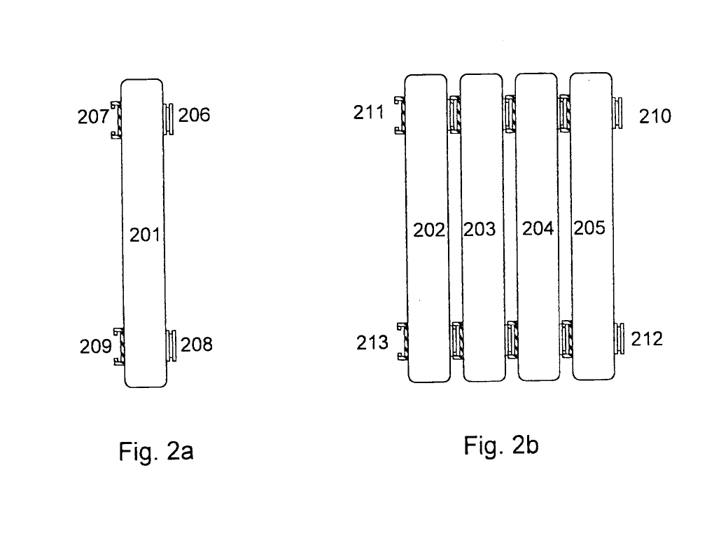

FIG. 2a is a diagrammatic representation of a preferred embodiment of an electrochemical energy store according to the invention;

FIG. 2b is a diagrammatic representation of a further preferred embodiment of an electrochemical energy store and an arrangement of electrochemical energy stores according to the invention;

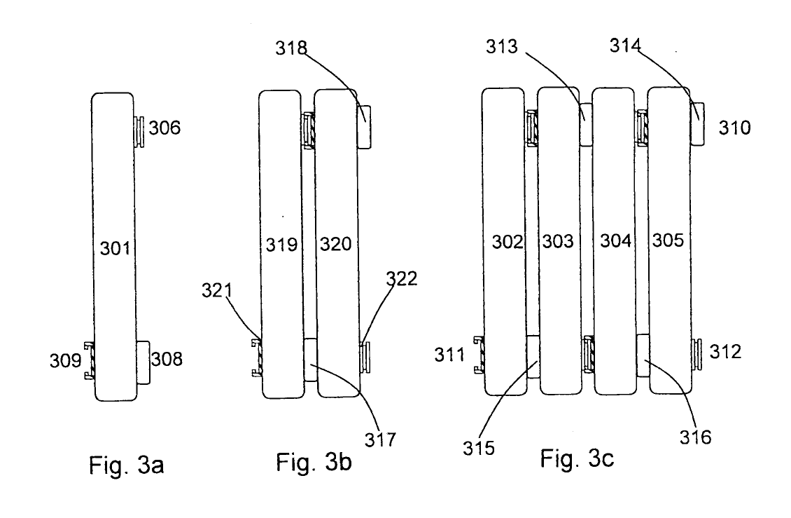

FIG. 3a is a diagrammatic representation of a further preferred embodiment of an electrochemical energy store;

FIG. 3b is a diagrammatic representation of a further preferred embodiment of an electrochemical energy store and an arrangement of electrochemical energy stores;

FIG. 3c is a diagrammatic representation of a further preferred embodiment of an electrochemical energy store and an arrangement of electrochemical energy stores;

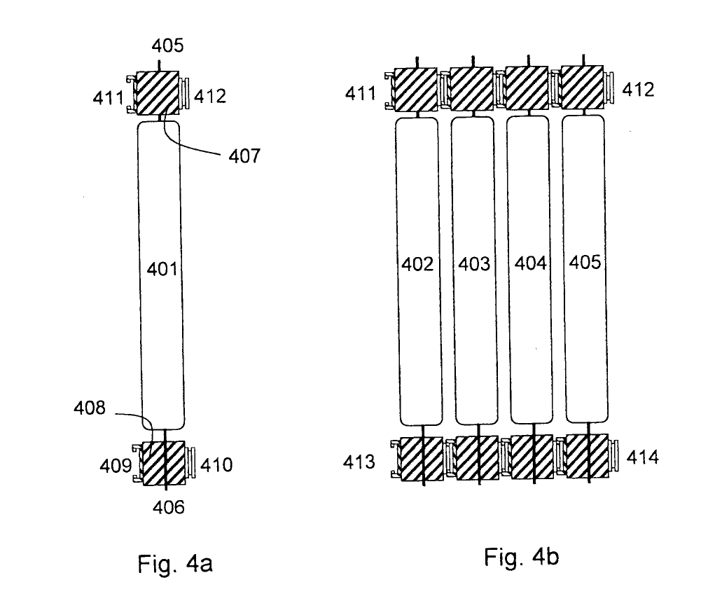

FIG. 4a is a diagrammatic representation of a further preferred embodiment of an electrochemical energy store;

FIG. 4b is a diagrammatic representation of a further preferred embodiment of an electrochemical energy store and an arrangement of electrochemical energy stores according to the invention;

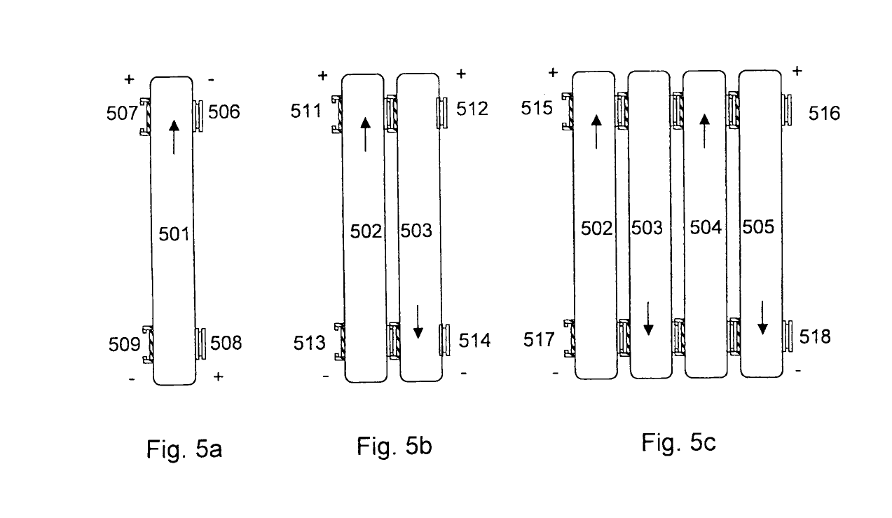

FIG. 5a is a diagrammatic representation of a further preferred embodiment of an electrochemical energy store;

FIG. 5b is a diagrammatic representation of a further preferred embodiment of an electrochemical energy store and an arrangement of electrochemical energy stores;

FIG. 5c is a diagrammatic representation of a further preferred embodiment of an electrochemical energy store and an arrangement of electrochemical energy stores according to the invention;

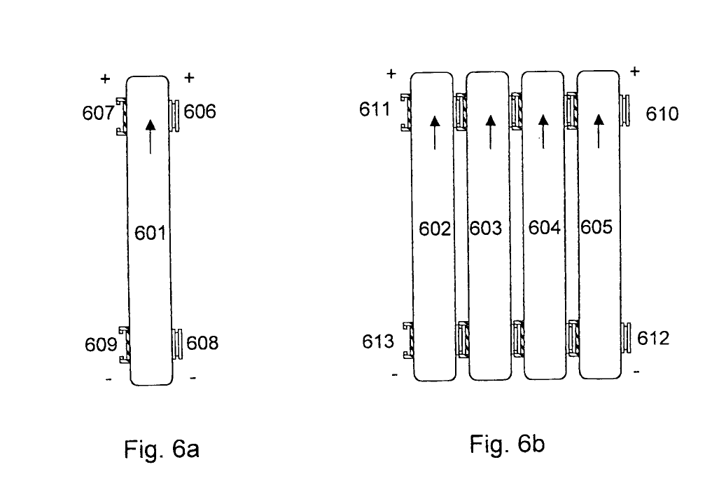

FIG. 6a is a diagrammatic representation of a further preferred embodiment of an electrochemical energy store;

FIG. 6b is a diagrammatic representation of a further preferred embodiment of an electrochemical energy store and an arrangement of electrochemical energy stores according to the invention;

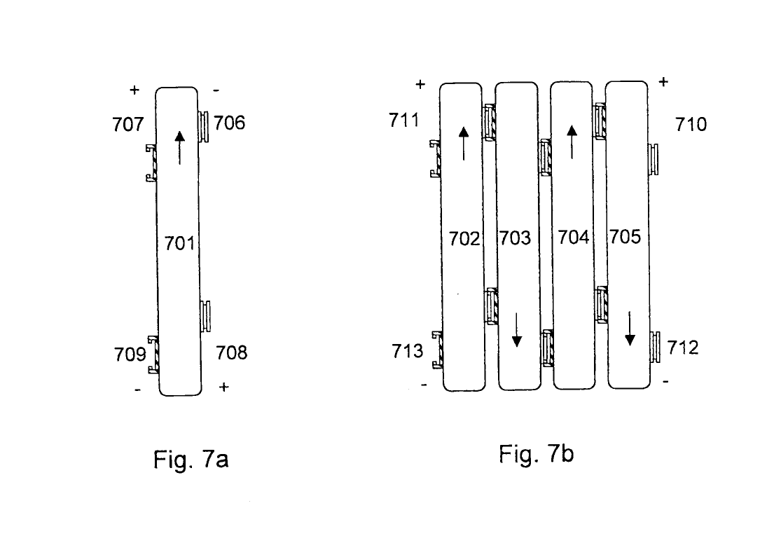

FIG. 7a is a diagrammatic representation of a further preferred embodiment of an electrochemical energy store;

FIG. 7b is a diagrammatic representation of a further preferred embodiment of an electrochemical energy store and an arrangement of electrochemical energy stores according to the invention.

A fundamental idea behind the invention is that an electrochemical energy store according to the invention has at least one first attachment element that is designed in such manner that when a first such electrochemical energy store, or at least a first such attachment element of said first electrochemical energy store of this kind is pressed against a second such electrochemical energy store or against at least a second such attachment element of said second electrochemical energy store of such kind an attachment is created between the first electrochemical energy store and the second electrochemical energy store.

The wide variety of options for constructing or designing such attachment elements is illustrated for example by the diagrammatic representation of an exemplary embodiment of such an attachment element in FIG. 1a. FIG. 1a shows a side view of a first attachment element according to the invention, in this example comprising a first disc 101, a second disc 103 of smaller diameter, arranged flat on the first disc and concentrically therewith. Finally, the attachment element shown here also has a third disc 102, for example having the same diameter as first disc 101, and also arranged concentrically with the other two discs.

The diagram of FIG. 1a, like the representations in all the other figures, is not necessarily drawn to scale. For example, the differences 104 and 105 between the radii of disc 103 and discs 101 and 102 are preferably significantly smaller than the radii themselves.

FIG. 1b shows a second attachment device complementing the exemplary first attachment device shown in FIG. 1a, which second attachment device is furnished with structural elements 106, 107, 108, 109 and 110. Structural elements 106 and 107 are provided for the purpose of engaging in the groove that is created or formed in the first attachment element of FIG. 1a by the differences in the disc radii, as is shown diagrammatically in FIG. 1c. In this context, dimensions 112, 116 and 113, 117 of form elements 106 and 107 preferably correspond to the dimensions 104, 105 of the groove in the attachment element shown in FIG. 1a. At the same time, dimensions 111, 114, 115 and 118 of form elements 108, 109 do not necessarily correspond to dimensions 112, 113, 116 and 117. FIG. 1c is a diagrammatic representation of a situation in which the attachment element shown in FIG. 1a is snapped into or engaged with the complementary attachment element shown in FIG. 1b.

Form element 101 of the attachment element shown in FIG. 1a is preferably an integral component of the electrochemical energy store, its housing, one of its conductors, or other form elements of the electrochemical energy store that are accessible from the outside. Alternatively, however, form element 101 may also be attached permanently to the electrochemical energy store, particularly the housing or one of the conductors thereof, for example by welding or in similar manner.

The attachment elements shown in FIGS. 1a and 1b are preferably designed as a single part, but they may also be produced by joining various moulded parts. Particularly moulded parts 108 and 109 are preferably manufactured from an elastic material so that the attachment element shown in FIG. 1a is able to snap into or engage in the attachment element shown in FIG. 1b easily when the elements are pressed together, and conversely the attachment created thereby may be released when a tractive force above a tractive force threshold is applied.

The tractive force threshold is determined in large part by the dimensions, shapes or material properties, particularly the elasticity and stiffness, of the materials used and may be adapted to meet the requirements of specific applications by the suitable selection of these parameters when constructing the attachment element. Just as a tractive force exceeding a given tractive force threshold must preferably be applied to separate the attachment elements according to the invention, a press-on force or press-on pressure must also exceed a given press-on force threshold so that the attachment elements create an attachment, preferably by causing complementary attachment elements to snap into or engage with each other.

FIG. 2 is a diagrammatic representation of a first embodiment of an electrochemical energy store 201 according to the invention with attachment element 206, 207, 208 and 209 affixed. In this example, complementary attachment elements 206 with 207 and 208 with 209 are located opposite each other on parallel surfaces of energy store 201, so that when a first energy store of such kind is pressed against a second energy store of such kind and this step is repeated an arrangement may be produced such as is represented diagrammatically in FIG. 2b. In this arrangement, four electrochemical energy stores 202, 203, 204 and 205 are fastened to each other, so that the arrangement created from these four energy stores in turn forms an energy store within the terms of the invention, and which possesses free attachment elements 210, 211, 212 and 213. As is evident particularly from the example of FIGS. 2a and 2b, but also with reference to FIGS. 3a, 3b, 3c, 4a, 4b, 5a, 5b, 5c, 6a, 6b, 7a and 7c, an arrangement of a plurality of electrochemical energy stores of these embodiments according to the invention again produces an electrochemical energy store that falls within the definition of the present invention.

Some embodiments of the invention provide that the attachment elements are connected in electrically conductive manner with electrical connectors of the electrochemical energy stores. These electrical connectors are not shown in the examples shown in FIGS. 2a and 2b. However, it is possible to route these electrical connectors out of the housing of the electrochemical energy store and connect them in electrically conductive manner to the attachment elements. This may preferably be assuring by passthroughs in the areas of the housing that are covered by the attachment elements, so these passthroughs are preferably not accessible from the outside, and are protected and particularly preferably sealed by the attachment elements.

One option consists in connecting a positive electrical connector to attachment elements 206 and 207 and a negative electrical connector to attachment elements 208 and 209. In this case, FIG. 2b shows an electric circuit in parallel of four electrochemical energy stores shown in FIG. 2a. Attachment elements 210 and 211 are also connected to a positive electrical connector, while attachment element 212 and 213 are connected to a negative electrical connector. In order to counter the danger of creating a short circuit by inadvertently using the electrochemical energy stores shown in FIG. 2a the wrong way round, in this context attachment elements are preferred that have pins of different shapes and/or arrangements to prevent such polarity errors, or at least to help address the problem. Corresponding embodiments are shown in FIGS. 7a and 7b.

Every one of the electrochemical energy stores or arrangements of a plurality of such electrochemical energy stores shown diagrammatically in FIGS. 3a, 3b and 3c, has only two attachment elements 306 and 309. In order to make it easier to attach such electrochemical energy stores to each other by the pressing method according to the invention, in this example a spacer 308 is provided, the purpose of which is to prevent the electrochemical energy stores from tilting while they are being pressed. This also helps to prevent the attachment elements from being damaged during pressing.

FIG. 3b shows an arrangement of two electrochemical energy stores 319 and 320 shown in FIG. 3a, wherein attachment element 306 of energy store 319 is engaged in attachment element 309 of the energy store 320 that is arranged symmetrically about the horizontal midline, in other words “upside down”. The result is an arrangement consisting of two individual energy stores, which itself forms an electrochemical energy store, but which has two free attachment elements 322 and 321, which are now on opposite sides to another. Here too, spacer 317 prevents the energy stores from being tilted during pressing. Spacer 318 serves the same purpose.

FIG. 3c shows an arrangement consisting of four energy store 202, 203, 204 and 205 with spacers 313, 314, 315 and 316 and having free attachment elements 311 and 312. If the attachment elements in this example are connected in electrically conductive manner with electrical connectors of the respective energy stores, complementary attachment elements 306 and 309 are preferably connected to electrical connectors (pins) of the opposite polarity. For this reason, the arrangements of FIGS. 3b and 3c represent energy stores such as are shown in FIG. 3a connected in series.

FIG. 4a shows a further example of an electrochemical energy store 401 according to the invention, the electrical connectors 405 and 406 protrude upwards and downwards out of the housing and are furnished with special bodies 407 and 408, which may preferably have the form of cooling elements and are preferably dimensioned such that the attachment element 411, 412, 409 and 410 are able to make a connection creating an attachment between energy stores of such kind by pressing two complementary attachment elements together, as is shown diagrammatically in FIG. 4b using the example of energy stores 402, 403, 404 and 405 with free attachment elements 411, 412, 413 and 414.

Some embodiments of the invention, which are shown diagrammatically for exemplary purposes in FIGS. 4a, 4b, 5a, 5b, 5c, 6a, 6b, 7a and 7b, provide that the electrical connectors of the electrochemical energy store are designed in such manner that when a first electrochemical energy store of such kind is attached to a second electrochemical energy store of such kind an electrical contact is made between at least a part of the electrical connectors of both electrochemical energy stores.

For this purpose, the electrical connectors of the electrochemical energy stores with this design are connected in electrically conductive manner to at least some of the attachment elements, so that electrical contact is made automatically when an attachment is created. In other embodiments of the invention, for example in the embodiments shown in FIGS. 4a, 4b and 4c, electrical connectors 405, 406 may themselves be equipped with attachment elements 409, 410, 411, 412, so that energy stores 401, 402, 403, 404, 405 are attached via their electrical connectors and an electrical contact is made through the electrical connectors thereof at the same time.

If these attachment elements as shown in FIGS. 4a, 4b and 4c are attached to electrically conductive components 407, 408, which are themselves in electrically conductive connection with connectors 405 and 406 and with the attachment element 409, 410, 411, 412 attached to them, attachment element 409, 410 and 411, 412 carry the potential of the components 407 and 408 that support them and thus also the potential of each of the electrical connectors (“conductors”) 405 and 406 that are connected thereto.

It is preferably provided in these and other embodiments that the electrical connectors and attachment elements are designed such that the electrical contact is interrupted if the attachment is disconnected.

Corresponding embodiments are shown diagrammatically in FIGS. 5a, 5b, 6a, 6b, 7a and 7b.

For example, FIG. 5a shows an embodiment of an electrochemical energy store according to the invention, in which attachment elements 506 with 509 and 507 with 508 are connected to the negative and the positive electrical connect- or respectively of the energy store. The arrow marked on energy store 501 in this FIG. 5a indicates that this energy store 501 is not symmetrical about its horizontal midline, which corresponds to the position in which the energy store is “upside down”. Instead, such an asymmetrical arrangement results in a reversal of the polarities of the attachment elements shown in FIG. 5a.

If the energy store shown in FIG. 5a is turned “upside down” the attachment element 509 connected to the negative electrical connector is then in the upper left position, in the former position of attachment element 507, which is connected to the positive electrical connector, and is now in the bottom left position. Attachment elements 506 and 508 change places in exactly the same way in this process, so that the previously “positive” attachment element at bottom right has now become a “negative” attachment element.

Although the attachment elements of energy store 501 change their polarities in this “turning upside down” process, their structure, that is to say their function as one of two complementary attachment elements, one might even say, their “gender”, remains unchanged.

The result of this is that only the arrangements shown in FIGS. 5b and 5c of the energy store shown in FIG. 5a, in which the arrows change their orientation alternatingly, are technically meaningful. Other arrangements of the energy store shown in FIG. 5a would be technically useless, because they would be connected to electrical short circuits, which is to be avoided. The arrangement of the energy stores with alternating arrow directions results in a parallel circuit of the energy stores, as is shown in FIGS. 5b and 5c. FIG. 5b shows a parallel circuit of two energy stores 502, 503 shown in FIG. 5a, which itself is an example of an energy store according to the invention with attachment elements 511, 512, 513 and 514 accessible from the outside. In contrast to the single energy store shown in FIG. 5a, the arrangement of two energy stores shown in FIG. 5b consists of two such energy stores that are identical about a line of symmetry along the horizontal centre line (“upside down”) not only in terms of construction but also electrically.

In order to avoid technically meaningless or dangerous interconnections, particularly the energy stores shown in FIGS. 2a to 7b are preferably equipped with polarity reversal protection. This polarity reversal protection can be realised in many different ways. The principle of operation shared by all such polarity reversal protection measures is an interruption of the structural symmetry of the energy stores shown in FIGS. 2a to 7b, which is not present on the electrical plane, and which results in the conflict described in the preceding. Such a symmetry disruption may be created in many different ways, preferably by replacing attachment elements 509 and 508, which have exactly the same structure as attachment elements 507 and 506, with attachment elements of different types, not shown in the figures, which do not fit attachment elements 506 and 507. This is preferably done in such manner that even an attempt to assemble them must fail before an undesirable or dangerous polarity reversal can occur.

There are also other options for creating a polarity reversal protection, for example by an offset arrangement of lower attachment elements 508 and 509 on the side walls of the energy store shown in FIG. 5a, as a result of which these offset attachment elements do not match the upper attachment elements of adjacent energy stores of the same kind after the energy store shown in FIG. 5a is turned “upside down”. A corresponding embodiment is illustrated in FIGS. 7a and 7b. Attachment elements 707 and 708 are vertically offset with respect to the positions of attachment elements 507 and 508 such that the structural symmetry present in FIG. 5a is fractured in FIG. 7a. If the energy store shown in FIG. 7a is turned “upside down”, attachment elements 706 and 707 do not take up the same positions as were previously occupied by attachment elements 708 and 709.

As will be evident from FIG. 7b, this effect of the offset arrangement of attachment elements when creating arrangements of multiple energy stores is automatically transferred to the energy stores that are compiled therefrom. The unit shown in FIG. 7b consisting of four energy stores 702, 703, 704 and 705 having alternating polarities and furnished with free electrical connectors 710, 711, 712 and 713, which are also the free attachment elements of this combined energy store, is neither structurally nor electrically symmetrical about the horizontal centre line.

Corresponding measures are preferably also taken to protect against the items shown in FIGS. 6a and 6b against polarity reversal. The energy stores shown in FIGS. 6a and 6b are also structurally symmetrical, but not electrically. If energy store 601 or the arrangement of the four energy stores 602, 603, 604 and 605 constructed therefrom is mirrored about the horizontal centre line, attachment elements 608, 609 or 612 and 613 assume the former positions of attachment elements 606, 607 or 610 and 611; however, the polarities of the electrical connectors do not change their sign.

However, unlike the items shown in FIGS. 5a, 5b, 7a and 7b, the energy stores shown in FIGS. 6a and 6b must be connected with the same polarity alignment, not with alternating polarities. This is indicted by corresponding arrows in FIGS. 5a, 5b, 6a, 6b, 7a and 7b.

In this context, the invention preferably provides for oppositely offset attachment elements, particularly preferably attachment elements 706, 707, 708, 709 offset horizontally and/or vertically with respect to each other 706, 707, 708, 709 and/or attachment elements of different shapes that do not correspond to each other, particularly preferably the use of a plurality of sets of attachment elements that are of complementary construction, and which fit each other within a set but do not fit the elements belonging to different sets.

1. An electrochemical energy store comprising:
at least a first attachment element that is designed such that when a first electrochemical energy store or at least a first attachment element of said first electrochemical energy store is pressed against a second electrochemical energy store or at least a second attachment element of said electrochemical energy store an attachment is created between the first electrochemical energy store and the second electrochemical energy store,
wherein at least one attachment element includes a permanent magnet.

2. The electrochemical energy store according to claim 1, wherein at least one attachment element is designed in such that the attachment is disconnected again under effect of an attractive force greater than an attractive force threshold.

3. The electrochemical energy store according to claim 1, wherein the electrochemical energy store includes at least two attachment elements that are complementary to each other, and which are constructed such that when at least a first attachment element of a first electrochemical energy store is pressed against a second attachment element, complementary to the first attachment element, of a second electrochemical energy store, an attachment is created between the first electrochemical energy store and the second electrochemical energy store.

4. The electrochemical energy store according to claim 3, wherein the first attachment element includes an outwardly protruding spherical body, which when pressed against a second attachment element complementary to the first attachment element engages with or snaps into a hollow spherical recess present in the second attachment element.

5. The electrochemical energy store according to claim 4, wherein at least one of the first or second attachment elements are produced at least in part from an elastic material.

6. The electrochemical energy store according to claim 4, wherein the first or second attachment element includes at least one spring element.

7. The electrochemical energy store according to claim 1, wherein at least one attachment element includes a permanent magnet.

8. The electrochemical energy store according to claim 1, wherein the electrical connectors of the electrochemical energy store are designed such that when a first such electrochemical energy store is attached to a second electrochemical energy store an electrical contact is created between at least some of the electrical connectors of both electrochemical energy stores.

9. The electrochemical energy store according to claim 8, wherein the electrical connectors of the electrochemical energy store are designed such that the electrical contact is disconnected when the attachment is separated.

10. The electrochemical energy store according to claim 1, wherein the electrical connectors or the attachment elements of the electrochemical energy store, at least part of which are electrically connected therewith, are designed such that they counteract a polarity reversal of the electrochemical energy stores, or the connectors thereof, when an arrangement is being constructed from at least two such energy stores.

11. An arrangement of a plurality of electrochemical energy stores according to claim 1.

12. An arrangement of a plurality of electrochemical energy stores according to claim 1, wherein adjacent electrochemical energy stores in the arrangement are fastened to each other in pairs by attachment elements that are designed such that when a first electrochemical energy store, or at least a first attachment element of said first electrochemical energy store, is pressed against a second electrochemical energy store, or against at least a second such attachment element of said second electrochemical energy store, an attachment is created between the first electrochemical energy store and the second electrochemical energy store.

13. A method for producing an electrochemical energy store, in which the housing or the electrical connectors of the electrochemical energy store are designed such that the electrochemical energy store has a first attachment element, which is designed such that when a first electrochemical energy store, or at least a first attachment element of said first electrochemical energy store, is pressed against a second electrochemical energy store, or against at least a second attachment element of said second electrochemical energy store, an attachment is created between the first electrochemical energy store and the second electrochemical energy store.

14. (canceled)

15. A method for producing an arrangement of a plurality of electrochemical energy stores, in which adjacent electrochemical energy stores are attached to one another in pairs by attachment elements so that an attachment is created between a first electrochemical energy store and a second electrochemical energy store by pressing a first electrochemical energy store, or at least a first attachment element of said first electrochemical energy store, against a second electrochemical energy store, or against at least a second attachment element of said second electrochemical energy store.

16. (canceled)

17. The method according to claim 13, further comprising:
producing an electrochemical energy store including
at least a first attachment element that is designed such that when a first electrochemical energy store or at least a first attachment element of said first electrochemical energy store is pressed against a second electrochemical energy store or at least a second attachment element of said electrochemical energy store an attachment is created between the first electrochemical energy store and the second electrochemical energy store, and at least one attachment element includes a permanent magnet.

18. The method according to claim 15 further comprising:
producing an arrangement of a plurality of electrochemical energy stores, each of the plurality of electrochemical energy stores including
at least a first attachment element that is designed such that when a first electrochemical energy store or at least a first attachment element of said first electrochemical energy store is pressed against a second electrochemical energy store or at least a second attachment element of said electrochemical energy store an attachment is created between the first electrochemical energy store and the second electrochemical energy store, and at least one attachment element includes a permanent magnet.
